(19) United States
(12) Patent Application Publication
(10) Pub. No.: US 2019/0082224 A1
(43) Pub. Date: Mar. 14, 2019

(54) System and Computer Implemented Method for Detecting, Identifying, and Rating Content

(71) Applicants: Nathaniel T. Bradley, Tucson, AZ (US); Joshua S. Paugh, Tucson, AZ (US); Brian Dean Owens, Plano, TX (US)

(72) Inventors: Nathaniel T. Bradley, Tucson, AZ (US); Joshua S. Paugh, Tucson, AZ (US); Brian Dean Owens, Plano, TX (US)

(21) Appl. No.: 16/125,236

(22) Filed: Sep. 7, 2018

Related U.S. Application Data
(60) Provisional application No. 62/555,984, filed on Sep. 8, 2017.

(51) Int. Cl. H04N 21/475; G06Q 50/00; G06Q 30/02; H04N 21/25; H04N 21/442

(52) U.S. Cl. CPC H04N 21/4756; G06Q 50/01; H04N 21/44222; H04N 21/252; G06Q 30/0282

(57) ABSTRACT

A system, method, and apparatus for rating content. A determination of content being received by a user is made. A user interface for receiving a user selection of bias of the content and rating truthfulness of the content is presented to the user. The user selection is received through the user interface. A number of user selections of at least bias and truthfulness are automatically compiled. Results indicating the user selections are communicated.

### RELATED APPLICATIONS

This application claims the priority benefit of U.S. application Ser. No. 62/555,984 filed Sep. 8, 2017.

### BACKGROUND

### I. Field of the Disclosure

The illustrative embodiments relate to content management. More specifically, but not exclusively, the illustrative embodiments relate to a system, method, and apparatus for detecting, identifying, rating, and managing content, sources, and profiles across one or more networks including the Internet.

### II. Description of the Art

In recent years available news sources and information has increased exponentially. In many cases it is difficult to verify the authenticity of each news source or piece of information. In particular, it may be difficult to quickly identify or negotiate biases that have become inherent in organizations and individuals. As a result, individual users are often left wondering about the content they reference or avoiding content altogether.

### SUMMARY OF THE DISCLOSURE

One embodiment provides a system, method, and apparatus for rating content. A determination of content being received by a user is made. A user interface for receiving a user selection of bias of the content and rating truthfulness of the content is presented to the user. The user selection is received through the user interface. A number of user selections of at least bias and truthfulness are automatically compiled. Results indicating the user selections are communicated. In another embodiment, a content rating system, platform, or server may include one or more processors and memories for executing and storing a set of instructions, wherein the instructions implement the process described above.

Another embodiment provides a system, method, and apparatus for aggregating content including automatically aggregating content from multiple news sources, determining biases associated with the news sources, determining content associated with each of the news sources, and displaying the content from the news sources with applicable visual indicators.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing content in accordance with an illustrative embodiment;

FIG. 2 is a flowchart of a process for aggregating content in accordance with an illustrative embodiment;

FIG. 3 is a flowchart of a process for determining bias in accordance with an illustrative embodiment;

FIG. 4 is a flowchart of a process for tracking content changes in accordance with an illustrative embodiment;

FIG. 5 is a flowchart of a process for creating content profiles in accordance with an illustrative embodiment;

FIG. 6 is a flowchart of a process for receiving ratings for content in accordance with an illustrative embodiment;

FIG. 7 is a flowchart of a process for communicating content based on bias in accordance with an illustrative embodiment;

FIG. 8 is a flowchart of a process for managing commentary in accordance with an illustrative embodiment;

FIG. 9 depicts a computing system in accordance with an illustrative embodiment;

FIG. 10 is a user interface of a browser extension for receiving ratings in accordance with an illustrative embodiment; and

FIG. 11 is a webpage for displaying content in accordance with an illustrative embodiment.

### DETAILED DESCRIPTION OF THE DISCLOSURE

The illustrative embodiments provide a system, method, apparatus, content rating platform, and computer implemented method for aggregating, rating, and managing content retrieved from one or more networks. The content may include webpages, mobile applications, text, files, images, audio, video, data, and other applicable information. In one embodiment, various content sources may be monitored, rated, ranked, and managed utilizing profiles created for organizations, individuals, entities, and so forth. The content may include URLs, website content, news source links, content feeds, newswire data feeds, data buckets, news outlets, news site content, television, radio, video/online video, virtual or augmented reality, social media, and any number of other types of content, or sources.

In some cases, news sources (and their respective Internet outlets) may have a general political bias. These biases result from executives, employees, culture, company philosophy or mission, target market, location/region, or so forth. Unfortunately, in modern times, it is very common for news outlets, authors, or content creators to have a bias, such as liberal or conservative bias. In one embodiment, terms that may be utilized to categorize content providers (or their associated bias) and may include far right, conservative, moderate conservative, independent, balanced, moderate liberal, liberal, far left, or no affiliation. Content providers may also be categorized or rated as libertarian, constitutional, socialist, and so forth. Other content providers may be categorized as parody, satire, fake news, alternative facts, unreliable sources, lacking valid sources, or a combination of categories or descriptors. The illustrative embodiments may be utilized to detect bias, categorize bias, rate content, and even rate bias levels associated with users, content providers, or so forth.

In one embodiment multiple news sources are integrated into content that is aggregated for analysis, processing, ranking, rating, filtering, reporting, and display or communications. Determinations regarding bias, political affiliation, truthfulness, and so forth may be performed for the benefit of the end-user. The illustrative embodiments may function as an automated process for providing tools for users to gather information about the content that they consume. The various embodiments may further strengthen specific input, categorizations, or information provided by users that interact with the system.

In one embodiment, a search request query may be submitted across a group of content specific sites. A search may be performed across multiple resources with the results aggregated for analysis, processing, or display to the user. The request may be submitted in the form of a name, profile data, text, news headline, topic, or keyword. The query may search available sources to retrieve information that meets the specified search parameters, profile, criteria, and so forth. The response may provide a match of the strongest or best match along with specific content, links, or so forth.

In one embodiment, the system may present a specialized website, application, browser-add in or extension, rating platform, or other tool for receiving user selections including rating content for truthfulness, up or down voting the content (e.g., like/dislike, thumbs up/thumbs down, up vote/down vote, etc.), rating the content for bias (e.g., liberal/conservative, capitalist/socialist, pro-gun/anti-gun, pro-choice/pro-life, etc.), receiving comments, and displaying or otherwise communicating the content accordingly. The system may allow common login information, such as Google, Facebook, Twitter, Instagram, LinkedIn, email/password, or others to be utilized to access the system. In one embodiment, the user may select to retain logged in for a specified time period (e.g., one day, two weeks, one month, indefinitely, etc.).

For example, a browser add-in may be utilized to allow a user to up vote or down vote content across the Internet. The user may also be able to determine bias associated with the content if applicable and rate the content for truthfulness. In one embodiment, the user may also comment on any content. The comments may be made without signing into the specific website associated with the content.

In another embodiment, content is identified and associated with a unique identifier. The unique identifier may be a URL or other assigned identifier generated by the system. The content may be determined from applicable web addresses, IP addresses, device identifiers, source names, or other applicable information relevant to the content, source of the content, authors, distributors, or so forth. For example, the content may be associated with an identifier that may used across sources regardless of distribution. Thresholds of similarities may be utilized to link content is the same or nearly the same so that superficial changes cannot be made to make content look new or unique when it is not. For example, content that is 95% the same may be determined to be the same content and associated with a single identifier. The illustrative embodiments may also utilize existing plagiarism tools or digital fingerprint creation for content (e.g., documents, blogs, posts, audio, video, etc.).

The user may then rate the content include an up vote or down vote. The user may also rate the truthfulness of the content from 0% true (or false) to 100% true (or completely true). In one embodiment, a sliding scale may be utilized to select the truthfulness of the content as determine by the user. The truthfulness may also be rated utilizing any number of charts, graphs, units (e.g., a truth total of 10 stars, five thumbs up, etc.). The default assumption may be that all content is 100% true unless otherwise rated. The user may represent an individual, organization, entity, group, business, or so forth. In some cases, users may be given added weight because of past successful history in categorizing content, education, profession, or so forth. The bias associated with the content may also be rated utilizing an applicable scale. For example, political content may be rated based on liberal or conservative bias from 100% liberal to 100% conservative. Colors, labels, and graphics may also be utilized to better help the user understand the ratings being given.

The various ratings and bias may be displayed or communicated for each user's vote as well as all applicable users. For example, a user may share their vote (or the standing vote of all users) with other users through messages (e.g., email, text message, in-app messages, etc.), social media posts, or other communications. Content may be separated based on the perceived ratings and bias information received from users. For example, content may be separated visually, audibly, or tactilely using different locations, time frames, or natural separators. The content may also be separated using labels, headings, color schemes, symbols, icons, images, or other relevant information. For example, content perceived as having a liberal bias may be shown under a liberal heading, in blue, on the left-hand side of a webpage whereas content perceived as having a conservative bias may be shown under a conservative heading in red, on the right-hand side of a webpage.

The content may include articles, web content/webpages, comments, commentary, opinions, imagery, cartoons, postings, audio files, video files, blogs, social media posts, or other distributable content whether digital or in print. In one embodiment, the system may utilize a webpage that aggregates content including Internet content/webpages, social media contents/feeds, commentary/opinion, and general reviews of content. The system may also utilize a browser extension or add-in, program, or application that allows a user to rate, review, and rank content for truthfulness and bias as the user naturally navigates, consumes, peruses, or visits content. The ratings, review, and ranking of content may be associated with the content identifier for display by a webpage of the system. The utilization of multiple pages may be utilized to view applicable content. The illustrative embodiments may also provide a system and method for providing comments, ratings, and useful user information across platforms, devices, systems, equipment, and devices.

The illustrative embodiments are particularly useful for helping a user rate, review, and assign perceived bias to content as well as see what other users are saying. In some embodiments, additional weight may be given to users or organizations that have been found to be particularly adept at impartially and objectively rating content to ensure the accuracy of the process. The illustrative embodiments help users (the general public) rate content found on the Internet and elsewhere and provide the results for general use. As a result, people have a clearer understanding of the bias, truthfulness, and popularity of the content that is meant to be objective, without “spin”, and not skewed. The illustrative embodiments help protect the information available on the Internet while still providing a real-time view of how the general public views the content. In some embodiments, the illustrative embodiments may be utilized by companies, organizations, or others to determine who the public, employees, or others perceive their content and messaging.

The illustrative embodiments do not relate to abstract ideas, but valuable information that may be shared, messaged, viewed, and communicated. This is particularly important when facing political issues, emotional subjects, and controversial ideas that must be discussed and addressed in a civil, open, and free society. The object is to help address limitations of free speech with even more free speech. The illustrative embodiments require capture content and user information and utilizing in new and unique ways for the benefit of the general public utilizing servers, databases, browser extensions, add-ins, and tools, mobile applications, and electronic distribution systems. The illustrative embodiments may be implemented by specific and customized devices, logic, software, or a combination thereof. In some embodiments, physical content, audio, video, or happenings may be automatically scanned or converted to digital content so that the processes herein described may be implemented.

The illustrative embodiments may be applied across the Figures and description without limitation or restriction. It is expected that some steps and processes may be rearranged and reordered and that well known processes and techniques may be combined with those concepts herein described.

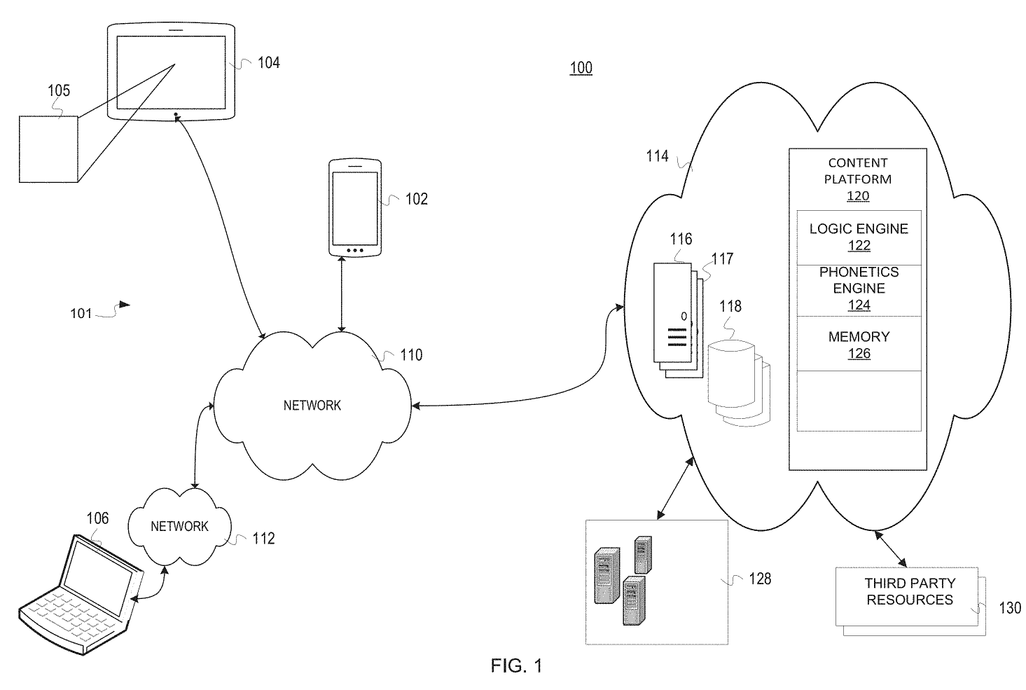

FIG. 1 is a pictorial representation of a system 100 for managing content in accordance with an illustrative embodiment. In one embodiment, the system 100 of FIG. 1 may include any number of devices 101, networks, components, software, hardware, and so forth. In one example, the system 100 may include a wireless device 102, a tablet 104 utilizing graphical user interface 105, a laptop 106 (altogether devices 101), a network 110, a network 112, a cloud network 114, servers 116, databases 118, a content platform 120 including at least a logic engine 122, a phonetics engine 124, and memory 126. The cloud network 114 may further communicate with sources 128 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, and other similar components that are not described herein for purposes of simplicity.

In one embodiment, the system 100 may be utilized by any number of users, organizations, or providers to aggregate, review, analyze, process, rank, and distribute content, users, and sources. In one embodiment, the content may refer to news content, however, the content may represent various categories of content as are herein described or referenced. The wireless device 102, tablet 104, and laptop 106 (altogether devices 107) are examples of common devices that may be utilized to view, watch, listen to, or otherwise interact with content. Other examples of devices 107 may include televisions, smart displays, entertainment devices, gaming systems, projection systems, virtual reality/augmented reality systems, or so forth.

The devices 107 may communicate wirelessly or through any number of fixed/hardwired connections, networks, signals, protocols, formats, and so forth. In one embodiment, the wireless device 102 is a cell phone that communicates with the network 110 through a 5G connection. The laptop 106 may communicate with the network 112 through an Ethernet or Wi-Fi connection. The cloud network 114 may aggregate, analyze, and process content and user requests across the Internet and any number of networks, sources 128, and third-party resources 130. For example, the networks 110, 112, 114 may represent any number of public, private, virtual, specialty, or other network types or configurations. The different components of the system 100 may be configured to communicate using wireless communications, such as satellite connections, Wi-Fi, WiMAX, 3G, 4G, 5G, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, 112, 114 of the system 100 may represent a single communication service provider or multiple communications services providers.

The sources 128 may represent any number of web servers, distribution services, media servers, platforms, distribution devices, or so forth. In one embodiment, the cloud network 114 (or alternatively cloud system) including the content platform 120 is specially configured to perform the illustrative embodiments.

The cloud network 114 or system represents a cloud computing environment and network utilized to aggregate, process, and distribute content. The cloud network 114 allows content from one or more service providers to be centralized. In addition, the cloud network may manage software and computation resources for remote management (e.g., through the wireless device 102, tablet 104, and laptop 106).

The cloud network 114 may prevent unauthorized access to data, tools, and resources stored in the servers 116, databases 118, and well as any number of associated secured connections, virtual resources, modules, applications, components, devices, or so forth. In addition, a service provider may more quickly aggregate, process, and distribute content utilizing the cloud resources of the cloud network 114 and content platform. In addition, the cloud network 114 allows the overall system 100 to be scalable for quickly adding and removing content providers, analysis modules, moderators, programs, scripts, filters, or other users, devices, processes, or resources. Communications with the cloud network 114 may utilize encryption, secure tunnels, handshakes, secure identifiers, firewalls, specialized software modules, or other data security systems and methodologies as are known in the art. In one embodiment, the cloud network 114 may interface tools, such as a web browser extension with a dedicated website (e.g., report webpage, feeds webpage, reviews webpage, commentary and opinion webpage, etc.) for recognizing content, associating an identifier, receiving user selections (e.g., ratings, bias, etc.), compiling the user selections, and sharing/displaying/communicating the user selection or general user selections.

Although not shown, the cloud network 114 may include any number of load balancers. The load balancer is one or more devices configured to distribute the workload of the content and search resources that are herein described to optimize resource utilization, throughput, and minimize response time and overload. For example, the load balancer may represent a multilayer switch, database load balancer, or a domain name system server. The load balancer may facilitate communications and functionality (e.g. database queries, read requests, write requests, etc. between the wireless device 102, tablet 104, or the laptop 106 and the cloud network 114. For example, new and unique fields and data may be stored based on the applicable ratings.

In one embodiment, the servers 116 may include a web server 117 utilized to provide a website and user interface (e.g., user interface 105) for interfacing with users. Information received by the web server 117 may be managed by the content platform 120 managing the servers 116 and associated databases 118. For example, the web server 117 may communicate with the database 118 to respond to read and write requests. The databases 118 may utilize any number of database architectures and database management systems (DBMS) as are known in the art. The servers 116 may also receive user ratings, reviews, bias information, and associate the data with the content. The servers 116 may associated information from individual users with the content to compile “votes” over time. In one embodiment, the servers 116 may coordinate information between one or more browser extensions/add-ins, mobile applications, and dedicated webpages.

In one embodiment, the system 100 or the cloud network 114 may also include the content platform 120 which is one or more devices utilized to enable, initiate, aggregate, analyze, process, route, and manage content and communications between one or more telephonic and computing devices. The content platform 120 may include one or more devices networked to manage the cloud network and system 114. For example, the content platform 120 may include any number of servers, routers, switches, or advanced intelligent network devices. For example, the content platform 120 may represent one or more web servers that performs the processes and methods herein described.

In one embodiment, the logic engine 122 is the logic that controls various algorithms, programs, hardware, and software that interact to aggregate, analyze, rank, process, and distribute content. For example, the logic engine may process the user selections including ratings, reviews, bias information, and commentary. The logic engine 122 may be specially configured to receive and compile user selections for communication. Various forms of mathematical or statistical analysis may also be performed for the content.

The phonetics engine 124 is logic that controls phonetic analysis of content received by the content platform 120. In one embodiment, the phonetics engine 124 may utilize machine learning and artificial intelligence to parse, analyze, and otherwise process the language of the content. In one embodiment, the phonetics engine 124 may analyze subjective/objective words, subjective intensifiers, presupposition language, politically affiliated metaphors and vocabulary, subtle bias cues, factive verbs, implicatives, hedges, biased language, entailments, flattering, vague, endorsements of viewpoints, assertive verbs, one-sided terms, curse words or defamatory language, and so forth. In another embodiment, the phonetics engine 124 may be integrated with the logic engine 122.

In one embodiment, cloud network 114 or the content platform 120 may coordinate the methods and processes described herein as well as software synchronization, communication, and processes. The described embodiments may utilize a web site to aggregate and process content from available sources. In addition, search options may be presented to users that access the website.

The third-party resources 130 may represent any number of resources utilized by the cloud network 114 including, but not limited to, government databases, private databases, web servers, research services, and so forth.

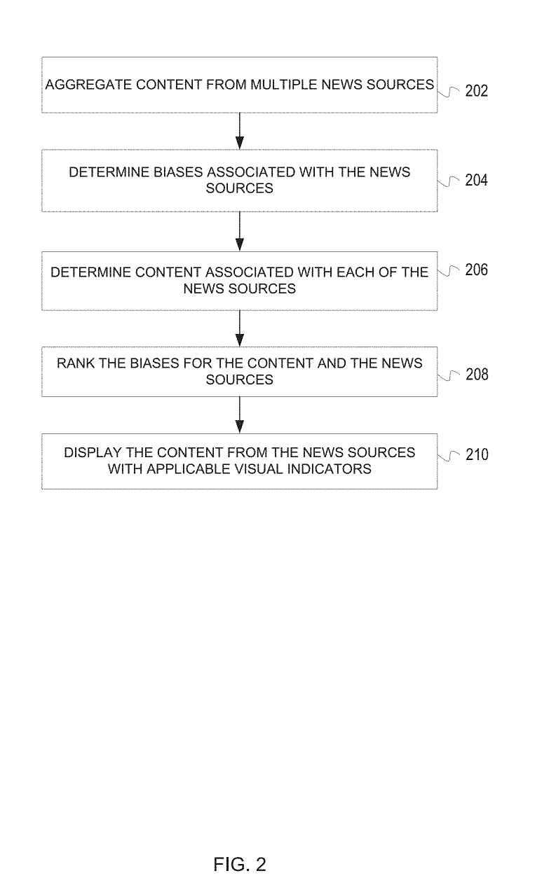

FIG. 2 is a flowchart of a process for aggregating content in accordance with an illustrative embodiment. In one embodiment, the method of FIGS. 2-4 may be performed by a cloud network, content platform, or other devices of the system 100 of FIG. 1 generally referred to as a system. The system may automatically communicate with any number of devices, services, users, organizations, entities, or other sources. In some embodiments, the content may be captured autonomously without user interaction. In other embodiments, the system may send requests that are provided based on human interaction or manual processes.

In one embodiment, the process may begin by aggregating content from multiple news sources (step 202). As noted, the aggregation may be performed automatically or based on specific requests. In one embodiment, the aggregated content may be stored in memories, databases, caches, discs, or other storage components. The content may be filtered, categorized, or separated as received based on the source, category of content, metadata, author, or so forth. Even though news sources are referenced, the content sources may represent any number of fields, topics, or categories (e.g., sports, medicine, education, entertainment, industries, work, etc.).

Next, the system determines biases associated with the news sources (step 204). The system may utilize any number of processes, steps, analytics, programs, algorithms, and analysis to determine the biases associated with the news sources and/or content. The biases may represent political, technical, racial, religious, philosophy, or other biases. The biases may be categorized, ranked, and recorded for subsequent reference. In one embodiment, the biases associated with a news source may be aggregated over time to provide an objective or subjective determination of bias. In one embodiment, the system may receive rating information associated with individual users or organizations to rate biases based on feedback. For example, the political bias of a site may shift through the release of daily news stories, content, commentary, and press releases that may define bias shifts. The shifts may be analyzed, tallied, and re-ranked over time as new content is released.

In some embodiments, where there is potentially fake news content, but the system is unable to fully verify or quantify the actual truth of the content, the system may poll other users to generate a group/crowd sourced opinion across various sample sets of users to properly determine biases and veracity of the content. The polls, surveys, or other information gathering initiatives may be shared across social media allowing users to post the content as well as post an associated survey regarding veracity.

Next, the system determines content associated with each of the news sources (step 206). The content may include posts, webpages, feeds, wires, tickers, electronic data, or any number of other types of content. The system may utilize any number of identifiers, whether included in the content or assigned by the system, to identify both content sources and the content itself. For example, content identifiers may include author, distributor, content provider name, IP address, industry identifier, website, or so forth.

Next, the system ranks the biases for the content and the news sources (step 208). The biases may be ranked on one or more scales (e.g., 1-10, far right, conservative, moderate conservative, neutral, moderate liberal, liberal, far left, color spectrums, etc.). Any number of ranking systems, including text, numeric/mathematical, visual, audio, or otherwise may be utilized and presented to users that access the system. By aggregating and evaluating bias, the system may measure a total tally of tone and bias of content as it is released from each site. The biases for the content as well as the source may be determined during step 208. For example, the system may determine websites that are reporting a political skew that is a mix of balanced news stories and those that have lower instances of biased language in the respective content. During step 208, the system may also validate and verify content and news sources. For example, the system may cross reference content between multiple sources to determine whether provided information is deemed to be accurate over time.

Next, the system communicates the content from the news sources with applicable visual indicators (step 210). In one embodiment, the content may be displayed utilizing a dedicated website, mobile application, computer program, channel, or so forth. The content may be communicated through display, playback, audio transmission, data communication, or so forth. The system may similarly communicate the bias and other applicable content information as determined or processed. The content from multiple sources may be displayed utilizing any number of visual, audio, or tactile graphics or other outputs. For example, changes across the political spectrum may be represented by the red to blue color spectrums. Icons, such as donkeys and elephants, or other applicable symbols may also be utilized. The visual indicators may be utilized with reference to content as well as sources. In one embodiment, visual indicators may correspond to the rankings that are determined over time for the content and the news sources.

In one embodiment, the system may display biases, tone, and other information for multiple sites as well as comparing the sites. In one embodiment, the system may indicate the validity and verification of content and sources through inaudible tones. In one embodiment, the system may utilize a secondary source verification process that is accomplished by the content generator/publisher based on inclusion of an inaudible tone as a means to confirm and verify the credibility of the source. For example, an inaudible tone may verify that the content is verified or from a verified source. The inclusion of the tone allows users to quickly verify if content is actually from an approved or confirmed source. The verification of sources may also be made available through the receipt or scan of the inaudible tone from digital or physical media (e.g., utilizing a microphone, camera, and application of a smart device).

The illustrative embodiments may also be utilized to source citations for scientific databases including scientific journals, scholarly articles, scientific content, and scientific publications through the indication and notification of instances where publication sources are fake, incorrect, or poorly documented. The system may utilize multilingual translation and search features to aggregate and process content utilizing multiple languages.

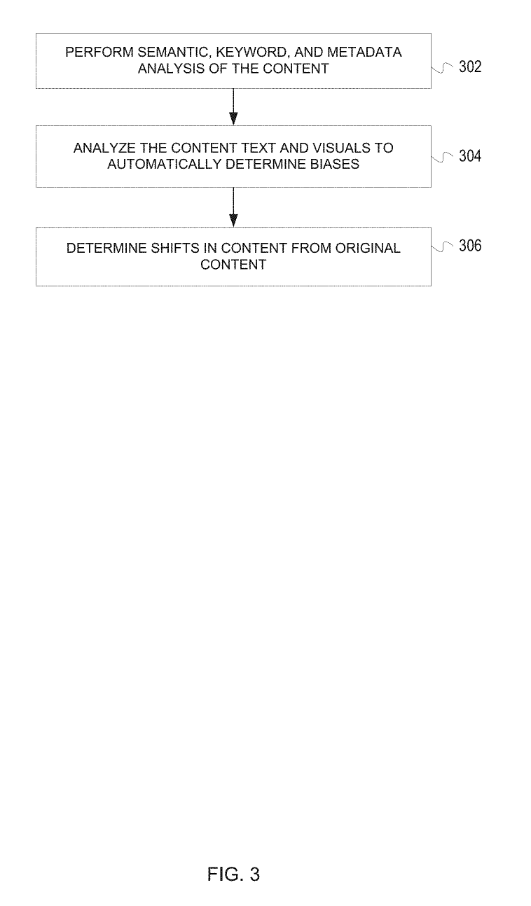

FIG. 3 is a flowchart of a process for determining bias in accordance with an illustrative embodiment. In one embodiment, the process of FIG. 3 may represent a step or process, such as step 204 of FIG. 2.

The process may begin by performing semantic, keyword, and metadata analysis of the content (step 302). In one embodiment, the system may automatically perform step 302 in response to news or other content being received, retrieved, or otherwise accessed. For example, particular words may be associated with particular political parties, political beliefs, or persuasions. The semantics, keywords, and metadata may be compared against databases that track data as well as associated or potential biases.

Next, the system analyzes the content text and visuals to automatically determine biases (step 304). The system may utilize the semantic data, keywords, and metadata to determine political bias. Historical information from content and associated commentary may be utilized to determine the biases. The determinations of biases and the associated ranking, rating, or categorization of such biases may be performed automatically utilizing logic, algorithms, as well as user input. The system may create a word map with emphasis on particular biases or tone (e.g., right or left leaning words) when performing analysis. The system may note the inclusion or non-inclusion of specific words, phrases, or images that may indicate a specific viewpoint or bias. The non-inclusion of words may be noted as representing a neutral point of view (NPOV). In some embodiments, news sources and other content providers may send content to the system for analysis before initially distributing the content to determine what bias levels may be included. A rating or report may be assigned by the system and sent to the news source.

Next, the system determines shifts in content from original content (step 306). In one embodiment, the shifts may be determined by analyzing the keywords used in the modified content. The keywords may indicate bias or shifts across boundaries. In one embodiment, the system may measure the spectrum of bias applicable to the content as published, referenced, or distributed. The spectrum of bias may also be applicable to news sources, such as websites. In one embodiment, the original content may represent an original thread in which the content was included. The system may determine dates during which the content shifted or was edited. The system may also note who performed the shift of content and the changes that were made. For example, changes from the original content may be noted and stored as a story moves from one source or provider to another. For example, the viral sourcing of news content may often politically alter the original tone or intended message of the original content. The illustrative embodiments help content providers and users determine if a source or content has a particular focus or bias and how that may have changed from the original distribution.

The shifts may also be noted utilizing a visual timeline. For example, through a news release timeline, the system may display initial content, release dates, images, content descriptors, title, assigned metadata, and so forth. The system may then determine which news outlets later sourced the content, potentially changing or adding bias to the content from the original content. By noting changes in content over time, the system catalogs and preserves the history of the content for subsequent reference and clarity.

The process of FIG. 3 may utilize various types of analysis to determine bias. For example, various determinations may be made quickly including that unbiased articles and content are voiced in a neutral point of view (NPOV). Neutral point of view would have limited use of the biased language including, but not limited to: 1) framing bias: uses subjective words or phrases linked with a particular point of view; 2) epistemological bias: linguistic features that subtly (often via presupposition) focus on the believability of a proposition; 3) stance bias is realized when the writer of content or text takes a particular position on a controversial topic and uses its metaphors and vocabulary; 4) linguistic analysis identifies common classes of subtle bias cues, including factive verbs, implicatives and other entailments, hedges, and subjective intensifiers; 5) biased language words include terms that are flattering, vague, or endorse a particular point of view; 6) entailments are directional relations that hold whenever the truth of one word or phrase follows from another; 7) Assertive verbs are those whose complement clauses assert a proposition (The truth of the proposition is not presupposed, but its level of certainty depends on the asserting verb. Whereas verbs like say and state are usually neutral, point out and claim cast doubt on the certainty of the proposition.); 8) hedges are used to reduce one's commitment to the truth of a proposition, thus avoiding any bold predictions or statements; 9) subjective intensifiers are adjectives or adverbs that add (subjective) force to the meaning of a phrase or proposition; and 10) one-sided terms reflect only one of the sides of a contentious issue. One-sided terms often belong to controversial subjects (e.g., religion, terrorism, etc.) where the same event can be seen from two or more opposing perspectives, like the Israeli-Palestinian conflict.

Other common sources of bias analysis may include a sentiment baseline generated utilizing a logistic regression model that only uses the features based on lexicons of positive and negative words; a subjectivity baseline generated utilizing a logistic regression model that only uses the features based on a lexicon of subjective words; and a Wikipedia baseline generated based on the words that appear in Wikipedia's list of words to avoid. Other applicable entities, organizations, or companies that have bias guidelines may also be utilized in the illustrative embodiments.

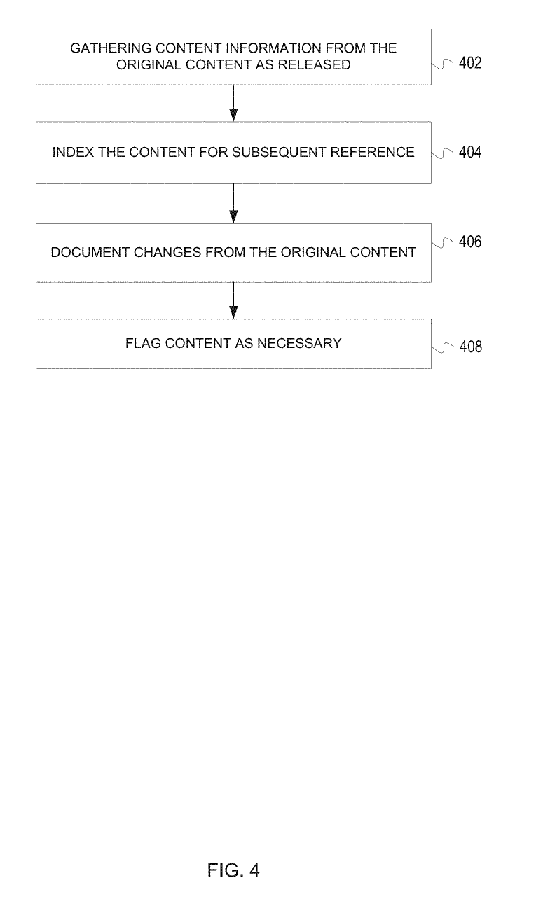

FIG. 4 is a flowchart of a process for tracking content changes in accordance with an illustrative embodiment. In one embodiment, the process may begin by gathering content information from the original content as initially released (step 402). The content information may include publication date, author, title, text content, word count, content formatting, original news source, references, footnotes, IP addresses, publication numbers/identifiers, metadata, or so forth.

Next, the system indexes the content for subsequent reference (step 404). The content may be analyzed and stored in one or more databases, memories, or so forth. In one embodiment, the content may be converted into any number of formats (e.g., text only, gif, etc.) that may be easily compared. The system may track, index and document each instance of confirmed fake, satirical, humorous, or verified news for each group of websites.

Next, the system documents changes from the original content (step 406). The changes may indicate content changes, attribution information, relevant dates, and so forth. In some embodiments, the system may ignore advertising, white space, or other formatting constructs. In some embodiments, the system may compare the comments, commentary, or additional information that may be tangentially related to the original content.

Next, the system flags content as necessary based on changes to the content information (step 408). In one embodiment, the system may mark or specify changes in the content from the original content. The system may send any number of communications denoting the changes in the content, such as text messages, email messages, in-application alerts, website pop-ups/notices, or so forth. In one embodiment, the system may flag content as confirmed/verified, unconfirmed, potentially fake, verified fake, questionable, or so forth. In one embodiment, the website may display the flag (e.g., indicator, icon, visual, etc.) along with the associated content for the benefit of the user.

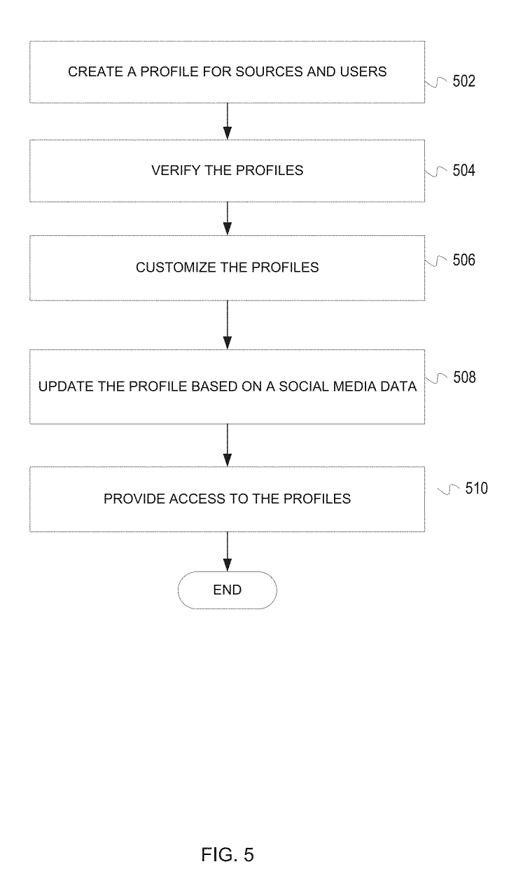

FIG. 5 is a flowchart of a process for creating content profiles in accordance with an illustrative embodiment. The illustrative embodiments also provide a method of aggregating profiles for users and sources. The process may begin by creating a profile for sources and users (step 502). The sources may represent news sources of various types and configurations. The system may also create profiles for individual users that consume content. For example, the user profile may specify demographic information, such as age, sex, race, home address, marital status, relationship status, interests, political affiliation, associated organizations, work, and so forth. In one embodiment, the profile is created from the user in response to a user request and user input. In other embodiments, the profile may be utilized to automatically track and manage relevant information. The profile may also be created based on publicly available information, such as government records (e.g., driver's license information, census information, voter registration, tax records, etc.), social media profiles, home purchase, leasing, or rental information, vehicle registrations, or other information and data that may be legally and ethically obtained.

Next, the system verifies the profiles (step 504). The system may verify the identity, credentials, or applicable information relating to each of the sources and users. For example, any number of databases, websites, services, social media networks, government bodies, organization information, or other systems, software, or processes may be utilized to verify the profiles include true and accurate information and data. As noted, the profiles may include any number of data points. The data may include voluntarily received information from the user as well as data that is retrieved from any number of sources. Relevant profile product and purchase indicators may include items of interest to the user, intended purchases, search data, travel plans, and advertising of interest. Many of the different profile data and information may be provided at the discretion of the profile owner, however, in some cases, the user may be required to provide information based on employment, business relationships, industry standards, professional requirements, licensing standards, organization requirements, or so forth.

Additional verifications and authentications that may be utilized by the system include background checks, ongoing criminal record checks and verifications, employment verifications, blood test (e.g., STDs, cancer, etc.), age verification, current verified picture, drug test, profile accuracy determinations, marriage status, divorce and alimony, demographic verification, passport data, travel data, financial data, security clearance, certifications, diplomas, licenses, accreditations, degrees, skill certificates, tax status, bond and insurance information, trust and foundation affiliation, political affiliation, special employment status (e.g., judge, politician, poll worker, police, firefighters, first responder, etc.), public or private employee, company insider status, hedge fund verification, associations approved (e.g., BBB, NRA, ABA, etc.), military service status, car insurance verification, health insurance verification, driver's license status, and so forth.

Next, the system customizes the profiles (step 506). In one embodiment, the search results of users may be customized utilizing the profile. For example, the system may note the user's interest in particular topics or subject matter. As a result, the system may notify the user of new content on specified topics of interest through the numerous and diverse sources available to the system. The system may also indicate when content becomes available from sources the user appears to be interested in. The profile may also track the user's consumption history for applicable content based on permissions granted by the user to better present information the user may be interested in. The profile may also present information that is opposite or diametrically opposed to the user's profile to provide an alternative viewpoint for the user. Content that is blatantly racist, sexist, bigoted, or encourages hate or violence towards any group or person may be automatically excluded. Offensive content may also be excluded based on ratings and other information provided by users, authorized users, organizations, or so forth.

In one embodiment, the system may be used by users and companies to aggregate their profiles as well as accessing other profiles. For example, a user's profile may indicate potential interest in a product based on the user's engagement with various content or articles in the past. As a result, the system may customize advertisements, product offerings, or other available information to both monetize the system and content as well as creating a more extensive level of user engagement. Previous testing, surveys, and other information may indicate products, services, and other information that the user may be interested in based on their profile. The user profile may also allow the user to control, modify, various types of marketing and advertisements that are presented to them through the system. For example, the system may display profile specific content and advertising based on the user profile data (e.g., millennial, generation Y, generation X, baby boomer, conservative, liberal, independent, green, constitutional, etc.). The system may also filter and limit access to content based on user selected profile criteria that may indicate information, such as education level, age, interest level, learning disabilities, elderly, Zip Code, or so forth for both retrieving and limiting content appropriate for the user based on the user profile.

Next, the system updates the profile based on social media data (step 506). The system may be automatically associated with any number of social media sites, services, databases, or so forth. For example, the system may utilize data from social media sites (e.g., Facebook, Instagram, Twitter, etc.), dating sites, hotels, timeshares, right shares, and other social and service-based outlets and resources. In one embodiment, the user may utilize a linking service available through the system to share their profile cross any number of partner websites and services. The expansion of the profile may provide for enhanced accuracy and added safety for users and service providers. In addition, it may help alleviate false or fake accounts that have plagued many companies and organizations in recent years. The higher number of user profile safety indicators may be utilized to provide enhanced social, dating, employment, service discounts, or other benefits available through the system. In one embodiment, the system may perform periodic, continuous, or systematic verifications of the applicable information and data to ensure there is not a relevant or critical status change (e.g., criminal background, employment verification, etc.).

Next, the system provides access to the profiles (step 510). The aggregated profiles for users and sources may be accessed by authorized systems, programs, affiliates, websites, applications, partners, or so forth. The profile may also be stored in a mobile application, integrated with a transaction profile (e.g., credit card, online payments, etc.), integrated into a transferable profile (e.g., inaudible tones, Bluetooth, infrared, etc.).

The system may be fee-based or advertising-based as an included value-added service. In one embodiment, the profile may assist users and sources in receiving additional benefits, access, discounts, and perks with various product or service providers, organizations, or so forth. For example, the profile may be utilized to provide service upgrades, reduce service fees, cheaper transportation, discount tickets, and any number of other products or services.

In another embodiment, the illustrative embodiments may be applicable to online job searches, recruiting services, employment outreach, and so forth. The illustrative embodiments may be applicable to any number of industries including governmental and private jobs. The system may be particularly beneficial for government/military jobs, lawyers, medical professionals, education positions, and so forth where background verification is important. In one embodiment, a job seeker looking for employment may elect to authenticate and compile their user employment profile across the resources of the system. As a result, potential employers or others may have verified and authenticated information available through the user's profile.

In one example, job seekers and employers may utilize the services of the system to ensure the profile of a user/employer is true and accurate. For example, an employer may verify the resume and work experience of the user utilizing the system. Jobseekers may improve their success rate by including additional verifiable elements of employee trustworthiness to their profile (e.g., security clearance levels, certifications, licenses, etc.). The user may provide additional information while uploading their profile to further stand out to potential employers. Employers may also prescreen potential employees based on a broad number of required or desirable profile elements. The ability to prescreen potential employees via their profiles may save businesses and organizations significant money related to criminal and background checks, reference verifications, credentialing, and so forth. Profile indicators utilized by the system may include any number of nondiscriminatory data, such as background and criminal check, indication of a criminal record, education, drug test status, government background check and security clearance, past work experience, reference verification, and other applicable indicators utilized to safely clear and hire employees. In many cases the higher the number of profile indicators, the more likely the user is to be hired. The combination of j ob content data as well as profiles may help employers and potential employees filter and recognize patterns within information creating a second-level organization of employment data.

In another embodiment, the system may be utilized to store, manage, and access HIPAA compliant medical record databases and other patient base data sources. In one embodiment a profile is created for each medical professional, employee, records clerk, or other individuals who have access to patient medical records. The system may be utilized to specify files and patient data that may be included or limited based on permissions associated with the user's profile. Access to patient data may be granted as needed based on privileges, permissions, and necessity. Patient data may be accessed based on a device, application, security card, password, inaudible tone or other information that is associated with the file (whether in digital or paper format). For example, physical files may include various file folders the have sensors to grant or deny access to specific folders. The profile may be utilized by any number of smart cabinets, smart shelves, or other systems that secure access to the patient records. The system may allow or deny access to specific file folders storing patient data as well as indicating that the files have been accessed or removed.

In another embodiment, the systems and methods herein described may be utilized for educational or instructional course management. The profiles may also be utilized for student/users and the corresponding content providers (e.g., colleges, universities, schools, institutions, education groups, etc.). The profile of the user may be utilized to access applicable course materials and resources. In addition, the system may support various tiered learning processes within the same educational platform. The system may also add, modify, or remove course content based on the profiles as well as the user's progress, grades, test scores, quizzes, or other evaluation information. The system may provide access to any number of learning systems. In one embodiment, the system may recommend additional content to supplement original course material.

In another embodiment, the system may be utilized to compare products. For example, various products may be compared based on price, features, verified sellers, reviews, shipping time/price, and other applicable information to a potential transaction. The system may also be utilized by sporting and gossip sites. In one embodiment, the system may draw correlations between real and fake content providers and news sources. As a result, users may be able to determine whether there is bias based on factual news that may have influence on sporting lines (e.g., betting) and game outcomes.

The illustrative embodiments may also be utilized for digital rights management (DRM) verification for digital items and data. In one embodiment, content may be tracked along with the providers or distributors of the content to ensure efficient and legal utilization of the content. The illustrative embodiments may also be utilized for stock news. The same methods of tracking bias and verified or false news may be very relevant. For example, the illustrative embodiments may detect stock hyping, negative campaigns, stock pumping, and so forth. The illustrative embodiments may also be utilized in the dark web to identify relevant information, such as drug trades, counterfeit items, guns and assassins, forgeries, hacking, and other illegal activities based on message boards, sites, and links. The illustrative embodiments may also be utilized for virtual reality, augmented reality, virtual reality banking, and so forth.

In another embodiment, the illustrative embodiments may be utilized by jobseekers or employees that are searching for new or different job/employment opportunities. The profiles of the potential employees and employers may be matched based on any number of criteria, parameters, associations, requirements, or so forth that are part of the associated profile.

The illustrative embodiments may also be utilized to eliminate the need for new account registration with different products, services, websites, companies, or so forth. The profile may be provisioned across any number of resources allowing the user to login with a single unified password, biometric, identifier, pin number, security question, or combination thereof.

The illustrative embodiments may also be utilized to create content safe resources and searching. In one embodiment, a kid safe search and content service may be provided in ensuring that adult, illegal, pornographic, and otherwise inappropriate content is not available (for children and adults alike). As noted, the illustrative embodiments may be utilized to detect bias based on phonetics, racial overtones, metaphors, past articles, previous content, tunnel vision, geographic based bias, nationalism, militia, affiliation, religious overtones, gender bias, LGBT bias, and other applicable biases or social separators.

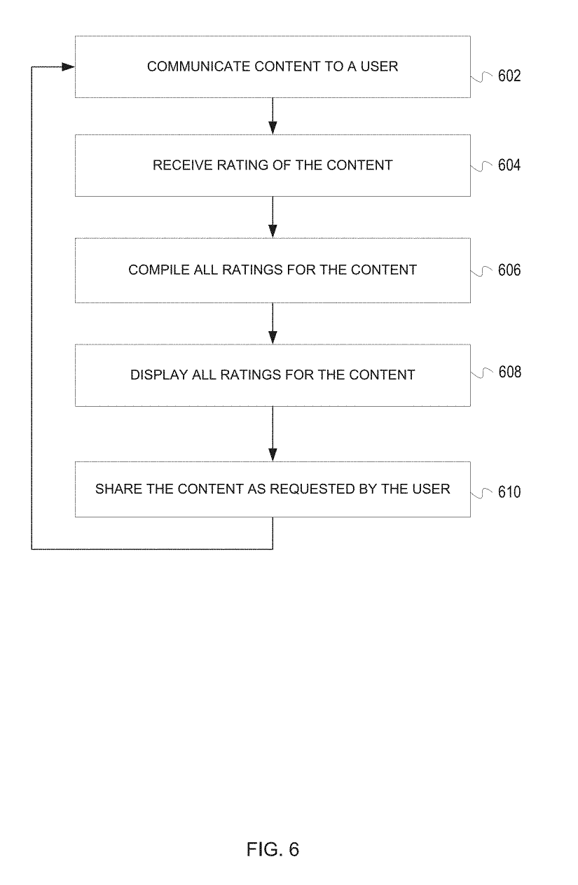

FIG. 6 is a flowchart of a process for receiving ratings for content in accordance with an illustrative embodiment. The process of FIGS. 6-8 may be performed utilizing a browser extension/add-in, program, mobile application, interactive web site, or so forth which are generally referred to herein as a “system”). The process may begin by communicating content to a user (step 602). The content may be communicated through any number of browsers, programs, mobile applications, messages (e.g., email, text, in-app messages, etc.). The content may be communicated visually, audibly, tactilely (e.g., braille), or utilizing any number of other communications methods.

Next, the system receives a rating of the content (step 604). The rating may include an up or down vote for the content indicating that the user likes or dislikes the content. For example, an up arrow, down arrow, thumbs up, comes down, smiley face, frowny face, or other indicators may be utilized to indicate whether the user likes or dislikes the content. Alternatively, the user may also vote that they neither like nor dislike the content. The rating may also include a rating of bias shown in the content as perceived by the user. For example, the user may rate the content from 0 to 100% liberal, and 0 to 100% conservative. The bias rating may be received utilizing a sliding scale, drop down menu, pie chart, bar graph, or so forth. In one embodiment, the bias rating is color-coordinated utilizing blue for a liberal rating, read for a conservative rating, and white for a rating that is considered neutral. For example, any content that is considered to be 20% or less liberal or conservative may be rated as neutral and shown in white. Any number of other ratings may also be available, such as independent, libertarian, constitutional, and other applicable political parties within the United States or other countries. For example, the user may alternative rating schemes as the most necessary for content that does not necessarily fall into the shown categories. Examples of other rating schemes for specific topics may include pro-choice/pro-life, capitalist/socialist, neutral/bigoted, legal/illegal, and so forth.

The rating may also include a rating for the truthfulness of the content. In one embodiment, the user may rate the content from 0% true (or false) to 100% true (or completely true). The user may also utilize a sliding scale to rate the truthfulness of the content from 0 to 100%. Other rating schemes may also be utilized including a total of 10 stars, five thumbs, or so forth. The truthfulness rating may also utilize colors, such as black and white (white for true, black for false) or green indicating the level of truthfulness.

In one embodiment, the system may present an indicator, such as an icon, graphic, or other cue indicating that the user may rate the content. For example, the user may select an icon, such as blue and red “B” that represents a browser extension (e.g., “Bled Scale” Chrome extension) for rating at least an up/down vote, perceived liberal/conservative bias, and perceived true/false content. In another embodiment, the user may copy content information, such as a URL, into the system to rate the content. In one embodiment, the user may be able to revise any portion of their “vote” expressed through the various rating components (e.g., up/down, true/false, liberal/conservative, etc.). It is not uncommon for people to change their mind based on pondering upon a subject or based on additional information that comes to light. In another embodiment, the vote of the user may be fixed or irretractable.

In one embodiment, each piece of content is assigned or associated with a specific identifier. The identifier may represent a URL, source/author, publishing/releasing party, or so forth. The identifier may also represent a unique identifier assigned by the system. In one embodiment, the ratings are associated with the identifier for the content. For example, the ratings may be associated with a particular URL corresponding to a news article.

Next, the system compiles all ratings for the content (step 606). The content may be rated by numerous users simultaneously, concurrently, and/or sequentially. For example, for popular news articles thousands or even millions of users may rate the content at once. The system ensures that each registered user is allowed to rate the content once. The system compiles the ratings without bias or interference. In some embodiments, special software or users may be utilized to detect, identify, and remove bots or other malicious devices/users.

The ratings may be compiled utilizing the specific identifier associated with the content. In one embodiment, the content and ratings are tracked utilizing a digital ledger as part of a block chain system. The system may compile the information over time to ensure accurate and unbiased results to provide information that is not easily falsified, manipulated, or tampered with. The system may utilize any number of programs or algorithms to compile information for content that is released in multiple formats. For example, an article by a single reporter may be released across multiple mediums (e.g., website, mobile application, etc.). The system may utilize information, such as the release date, author, publishing/releasing parties, title, metatags, content, known publishing agreements/arrangements, and so forth to associate the content across mediums with the assigned identifier. For example, the content may be analyzed utilizing the words/images and components of the content to generate the identifier (e.g., a digital fingerprint for the content). As a result, all ratings may be associated with the identifier/content. Various thresholds may be utilized to associate the content with the identifier. For example, if content for webpage B is 90% the same as the content for article A released through a mobile application, the user ratings may be associated with a single identifier (e.g., https://crazynewsforallyall.com/123638, xeg1236923b, etc.).

Next, the system displays all ratings for the content (step 608). The system may display ratings as received during the process of FIG. 6. As a result, individual users may be able to view ratings in real-time or as a snapshot based on selection of the applicable rating tool, extension, program, platform, or other part of the system. The users may be able to see how content for a specific article, site, or other content changes or is revised in real-time.

Next, the system shares the content and associated user rating as requested by the user (step 610). The user may share the content and associated rating utilizing any number of messages (e.g., text, email, etc.), social media post, snapshot/image, or other similar process. In one embodiment, the content may be shared utilizing a hyperlink. The rating information may specify how the user upvoted or downvoted the content, rated/ranked bias, and the truthfulness assigned to the content by the user. The rating information may also show how all other users have rated the content. To the extent user profiles or associated information is available, it may be utilized to show ratings by demographics, cohorts, groups, self-selecting individuals, or others may be shown (e.g., forty percent of teenagers voted this false with a 30% liberal bias, 20% of African Americans upvoted this as true with a 25% conservative bias, etc.).

The process of FIG. 6 may be performed repeatedly. For example, the user may be navigating content available through a browser or application and may choose content to rate as a public service, for fun, based on emotion, based on shared content (e.g., friends, family, acquaintances, etc.).

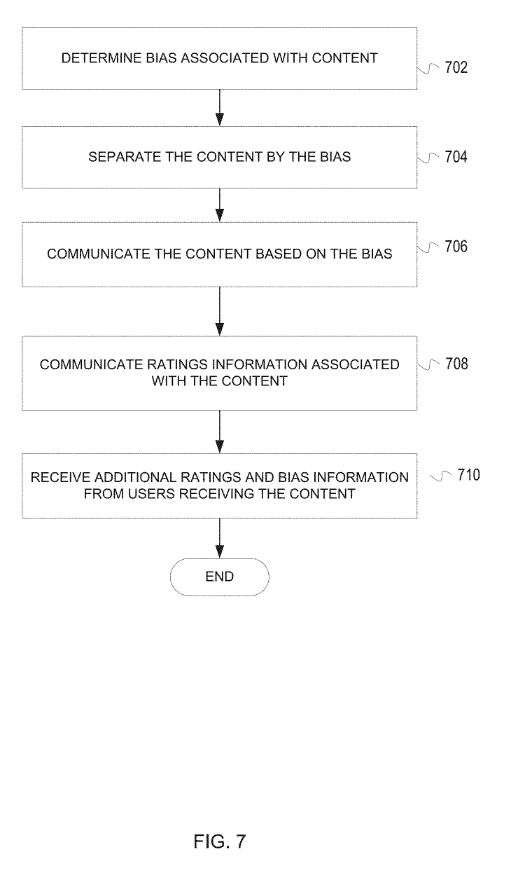

FIG. 7 is a flowchart of a process for communicating content based on bias in accordance with an illustrative embodiment. The process of FIG. 7 may begin by determining biases associated with content (step 702). In one embodiment, an impartial or authorized party, group, or organization may determine bias associated with the content. In another embodiment, the biases associated with the content may be determined by multiple users. The biases may be determined automatically by the system in response to voting/rating performed by a number of users (e.g., registered users, guests, etc.).

Next, the system separates the content by the biases (step 704). In one embodiment, the content is separated utilizing a database, numbers, or ratings values associated with the content.

Next, the system communicates the content based on the bias (step 706). The content may be separated and communicated utilizing one or more of locations (e.g., left side of a webpage for liberal content and right side of a webpage for conservative content), identifiers, labels, colors, symbols, images, or other applicable information. In one embodiment, once a threshold of users, such as 500 users have assigned bias, the content may be separated.

In one embodiment, the system may utilize a webpage to show content rated as having a liberal bias with an image, title, and source on the left side of a webpage in blue and conservative bias with an image, title, and source on the right side of a webpage. Additional information, such as author, release date, and other information may also be communicated. In addition, to reduce content for a report based aggregated site, the image and source may be removed, and the title may be assigned by the system or an administrator/manager/power user of the system. The content may be configured to be re-separated or moved based on the ongoing or real-time votes. For example, content that was originally rated as 25% conservative may change over time to be rated as 30% liberal. In another example, content that was originally rated as 30% liberal may be rated as neutral. Neutral content may represent one or more thresholds utilized to show the content is not necessarily biased one way or another (e.g., anything less than 10% liberal or 10% conservative). As previously noted, any number of other rating schemes may also be utilized to show, illustrate, or otherwise communicate bias.

Next, the system communicates rating information associated with the content (step 708). The system may show ratings associated with the content. The rating information may be specific to the user viewing, listening, or otherwise consuming the content if previously submitted by the user. For example, the system may communicate how the user has currently or previously rated the content. The rating information may also include general rating data available across all available users or selections of users (e.g., cohorts, selected demographics, organizations, self-identifying users, etc.). The system may also communicate information, such as webpage views, return hits, number of times the content was shared, number of comments, mentions of the ratings, or so forth.

Next, the system receives additional ratings and bias information from users receiving the content (step 710). As noted, ratings and bias information and data may be received in real-time. The system may be configured to display the ratings and bias information for sharing. The addition of the ratings and bias information may be particularly beneficial to users that want to see how others have rated or ranked content. In one embodiment, the user may select to indicate that bias information is not applicable. If a threshold of users select a radio button or other indicator indicating that bias is not relevant, the bias information may be removed or only shown if selected. For example, an article on upcoming battery technology may be irrelevant with regard to liberal/conservative bias, and, as a result, may not be displayed by the system. An administrator may also review content to selectively remove bias information associated with content based on ratings, nonengagement, commentary, or so forth.

In one embodiment, the system may be a program that displays additional information on top of a known website, such as ratings, bias, and so forth. For example, although not supported by a website the system may utilize white space, advertisements, components, or areas near the content to display the applicable ratings and bias information (e.g., up/down votes, liberal/conservative bias, true/false ratings, etc.).

In another embodiment, the system may also allow user comments. As a result, individual users may not be required to sign into website to generate comments. A login utilized for the system may be utilized to provide comments to all applicable digital content. For example, a Google, Facebook, Twitter, email, guest, or other supported login may be utilized by the system. The comments may be aggregated and displayed as described herein. In addition, individual comments may be rated up/down, true/false (or percentage true or numerical value), or liberal conservative (or percentage or numerical value liberal/conservative). The system may utilize any number of databases and associated fields to add/record/write, update, manage, and access the applicable information, such as content information, content identifiers, ratings, views, shares, and so forth without limitation. In one embodiment, the process of FIG. 7 may be utilized for a report page (e.g., “Bled Report” showing both blue/liberal and red/conservative content) for separating and displaying content with the applicable user ratings, values, comments, data, and information.

In one embodiment, opposing viewpoints of a subject may be displayed across from each other, proximate, or adjacent to encourage users to read or consume content that includes all sides of an argument. For example, content supporting and opposing the current president of the United States may be displayed proximate each other with the associated bias and rating information displayed to encourage friendly discourse and the free exchange of ideas.

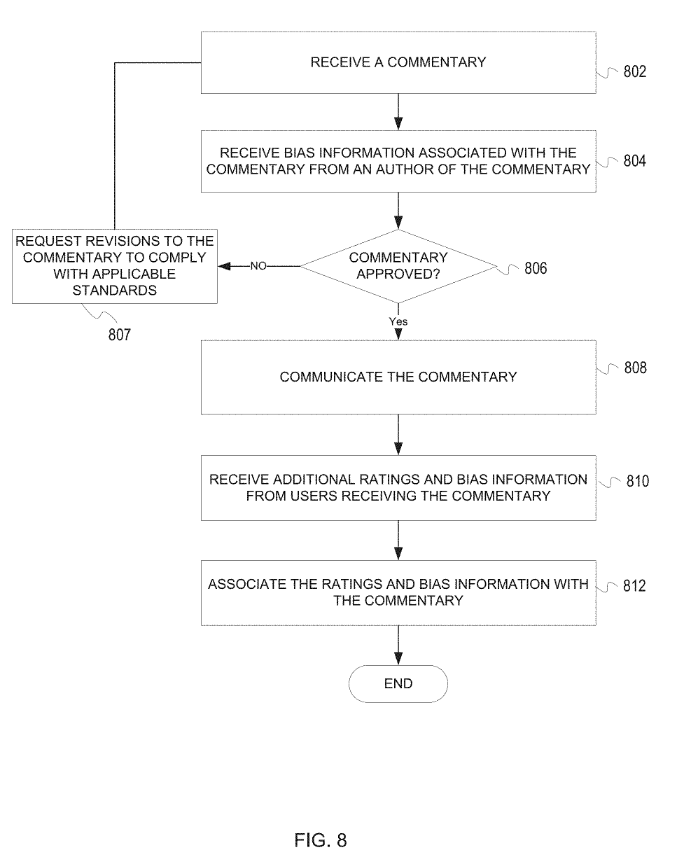

FIG. 8 is a flowchart of a process for managing commentary in accordance with an illustrative embodiment. In one embodiment, the process may begin by receiving a written commentary (step 802). The commentary represents more than a simple comment. The commentary is meant to be a well-written or generated article, opinion, or content piece that utilizes facts and available information to comment on any number of topics, such as politics, health, games, automobile/motorcycles last recreational vehicle, technology/information technology, sports, home and recreation, music, cinema, loving family, women/men, religion, business/finance, academic subjects, questions, and any number of other innumerable categories. In one embodiment, the system may provide a text editing program or application, presentation software, or allow the user to record audio, video, or other applicable content as part of the commentary. The system may also allow the user to upload comment that is formatted (e.g., document, audio, video, presentation, etc.) utilizing an external tool, program, platform, or so forth (e.g., Google Docs, Microsoft Word, PowerPoint, Adobe, etc.).

Next, the system receives bias information associated with the written commentary from a writer of the written commentary (step 804). The written commentary may be associated with multiple writers; however, a single writer may initially categorize the bias associated with the written commentary. In other embodiments, each applicable writer may be able to enter bias information associated with the written commentary into the system.

Next, the system determines whether the commentary is approved (step 806). The system or site may have any number of rules, regulations, suggestions, or guidance that must be adhered with for the commentary to be approved. For example, the commentary may not include inflammatory or hate speech that attacks a person or group on the basis of race, religion, ethnic origin, national origin, sex, disability, sexual orientation, or gender identity, age, or other discriminatory criteria. The system may also prevent publishing content that is pornographic or has no useful or socially redeeming purpose. To encourage positive discourse, the system may prevent unnecessary or excessive vulgar or crude language. In one embodiment, the system may utilize any number of keywords, phrases, text, or associated analysis to determine whether the written commentary will be approved. For example, the written commentary may be automatically run through a processing program in response to being submitted by a user. If the written commentary passes the processing program, it may be sent to an administrator, editor, power user, or other party authorized to approve the communication or display of the written commentary. In one embodiment, the written commentary may be required to be approved by both a self-identified liberal editor and a conservative editor associated with the system before being published.

If the commentary is not approved during step 806, the systems requests revisions to the commentary to comply with applicable standards (step 807). The user may be required to remove content, add facts/support, or otherwise comply with applicable standards. The revisions requests may be automatically requested based on the determination of non-compliance with the applicable standards or based on administrator feedback. For example, problem words, phrases, statements, images, or paragraphs may be noted. Next, the system receives a commentary (step 802) or a revised commentary.

If the commentary is approved during step 806, the system communicates the commentary (step 808). In one embodiment, the commentary may be posted or otherwise displayed. In one embodiment, the commentary may be communicated through a dedicated webpage, such as a commentary and opinion webpage. The commentary may also be communicated as a message to one or more recipients. The commentary may be separated or positioned based on categorization of the content. For example, the commentary may be separated into liberal/conservative content/columns or so forth. Users may have specified that they want to receive new content based on one or more of rating, bias, author, source, or other applicable information.

Next, the system receives additional ratings and bias information from users receiving the commentary (step 810). As noted, the system may associate the ratings and bias information with an identifier for the content. Rankings may also be generated for the commentary, such as views, up/down votes, and so forth.

Next, system associates the ratings and bias information with the commentary (step 812). The ratings and bias information may be compiled from any number of users over time. The ratings and bias information may also be reset daily, weekly, monthly, or yearly. For example, main webpages or content providers may be rated and reviewed for specific time periods (e.g., msn.com, foxnews.com, cnn.com, huffingtonpost.com, breitbart.com, usatoday.com, yahoo.com, reddit.com, etc.). The ratings and bias information may be specified by a default or specified time period.

The system may also display or communicate the commentary as well as the associated ratings, bias, and ranking information. This information may also be displayed as part of step 808.

The potential uses for the illustrative embodiments are innumerable, including, but not limited to, standard web searches, filtered web searches (e.g., safe content), social media, dating sites, job search/employment, rental services, hotels, time share services, vacation rentals, company due diligence, corporate background checks, Internet based news outlets, fact and bias verification, parody and satire, fake news verification, grouping similar content/service based websites, content libraries, portals, inventory management/real-time product inventory, art galleries, junk yards, and so forth. The profiles created, managed, and updated for the illustrative embodiments may be used for social media, dating sites, job applications, hotels, time shares, rideshare/taxis, government records, SEC/financial audits, political campaigns, airlines, doctors, nurses, caregivers, chiropractors, yacht/boat club, price comparisons, content libraries, human resources, and so forth.

The illustrative embodiments may also be implemented as applications, operating systems, kernels, scripts, add-ons, extensions, programs, wearables, devices, credit cards, inaudible tones and receivers, radio frequency identifiers, handheld scanners, Internet of things (IoT) devices, or hardware that may be implemented by other users and groups. The system may allow for profile matching based on similarities. As a result, users with similar interests may find each other or be otherwise matched. For example, the illustrative embodiments may be utilized for dating, investing, medical conditions, team building, project management, sports groups, clubs, hobby groups or other specified interests, requests for service, or social or consumer needs.

The illustrative embodiments provide a system method, apparatus, web server, and content platform for aggregating content and profiles. The profiles may relate to various sources, services providers, users, and so forth. For example, the content may represent news content, product information, service details, organizational information, general knowledge and so forth. The illustrative embodiments may be available through websites, URLs, virtual resources, wire services, dedicated devices, and so forth. The illustrative embodiments may be accessed through a network, such as the Internet, private networks, and so forth. The data may be retrieved via a smart phone, tablet, applications, wearables, system on a chip, radio frequency identifiers, inaudible tones, and other devices, systems, and/or components. Data access may be limited utilizing the profiles, permissions, authentications, verifications, identifiers (e.g., username, passwords, etc.), requirements, settings, and so forth as set by the administrators/managers of the system, content providers, and users. As a result, the ability to access data may be granted, modified, or limited in real-time.

The available information may be retrieved and updated automatically. For example, data may be updated continuously, periodically, at set intervals, based on specified events, or so forth. In another embodiment, user input may be required to enter information or verify the provided information. As noted, the illustrative embodiments automatically determine bias, lean, skew, deviations, variations, or so forth from the truth, norms, price, standards, thresholds, or so forth. For example, the illustrative embodiments may be utilized to determine political lean and bias for web content. In another example, the system may cross-reference new content across the fake news archive to indicate instances where the search results are a strong match indicating potentially fake or biased news.

The illustrative embodiments further provide a system, method, and devices for aggregating content and sources. The illustrative embodiments may be utilized to track the veracity and authenticity of content that is distributed through multiple sources. Multiple profiles may be utilized to track individual users as they consume content as well as the content providers themselves. The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

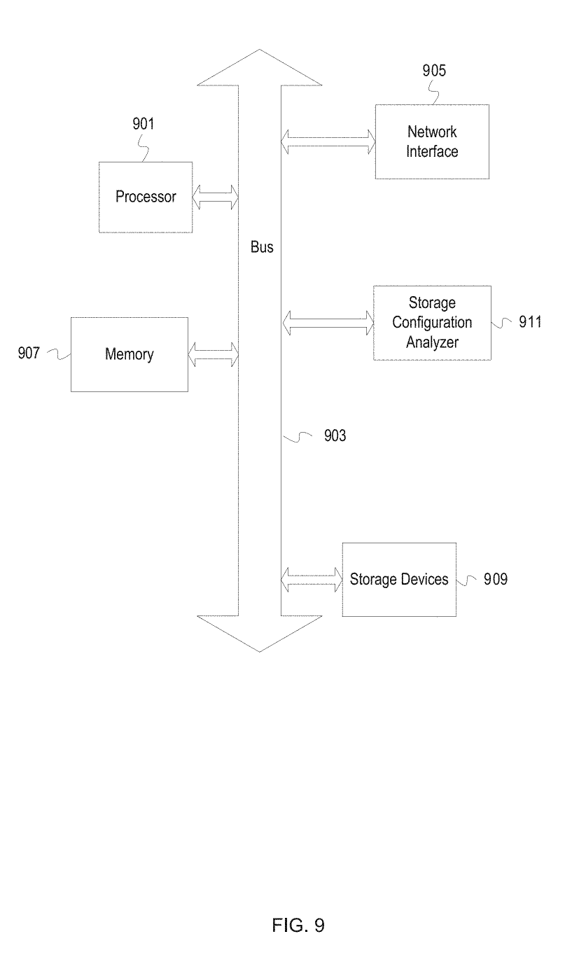

FIG. 9 depicts a computing system 900 in accordance with an illustrative embodiment. For example, the computing system 900 may represent a device, such as the wireless device 104 or tablet 116 of FIG. 1. The computing system 900 may represent a host device, target device, or environmental device. The computing system 900 may determine signal strength (e.g., RSSI), available environmental devices and their associated identifiers, execute location applications, receive user input, and provide audio, video, textual, visual, or tactile feedback to find the target devices, or so forth. The computing system 900 includes a processor unit 901 (possibly including multiple processors, multiple cores, multiple nodes, and/or implementing multi-threading, etc.).

In one embodiment, the computing system 900 includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system 900 also includes a bus 903 (e.g., PCI, ISA, PCI-Express, HyperTransport®, InfiniBand®, NuBus, etc.), a network interface 905 (e.g., an ATM interface, an Ethernet interface, a Frame Relay interface, SONET interface, wireless interface, etc.), and a storage device(s) 909 (e.g., optical storage, magnetic storage, etc.). The system memory 907 embodies functionality to implement embodiments described above. The computing system 900 may also include one or more of a receiver, transceiver, or signal detector for determining an identifier of other wireless device, signal strength, and other information (e.g., relative direction, used signal protocol, etc.). The system memory 907 may include one or more functionalities that facilitate determining a location and finding/locating a target device. Code may be implemented in any of the other devices of the computing system 900. Any one of these functionalities may be partially (or entirely) implemented in hardware and/or on the processing unit 901. For example, the functionality may be implemented with an application specific integrated circuit, in logic implemented in the processing unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901.

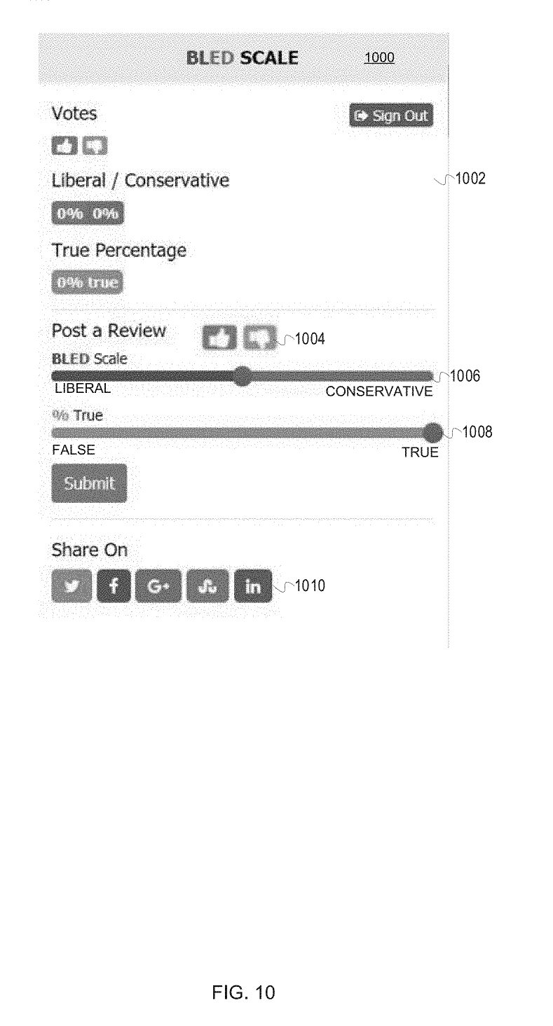

FIG. 10 is a user interface of a browser extension for receiving ratings in accordance with an illustrative embodiment. As shown, the user interface 1000 may represent a browser extension or add-in. The user interface 1000 may utilize any number of memorable names or headings that may be trademarked, white labeled, or proprietary.

In one embodiment, the user interface 1000 allows a user to up vote or down vote content. For example, as the navigates web content, the user may select to provide a user selection which may include an up vote/down vote, bias rating, and/or truthfulness rating. In some embodiments, not all information may be applicable, such as bias information or truthfulness content. The user interface 1000 may also include a selection component indicating not applicable (e.g., radio button, toggle, etc.).

Results 1002 may indicate how the content has been rated and reviewed by other users so far or for a specified time. For example, the results 1002 may show up votes and down votes (e.g., thumbs, stars, arrows, positive and negative numbers, etc.), the percentage of users that have voted the content as having a liberal or conservative bias measured in percentages, values, or other indicators, and how the users have rated the truthfulness of the content from zero percentage true (or false) to 100% true (or completely true).

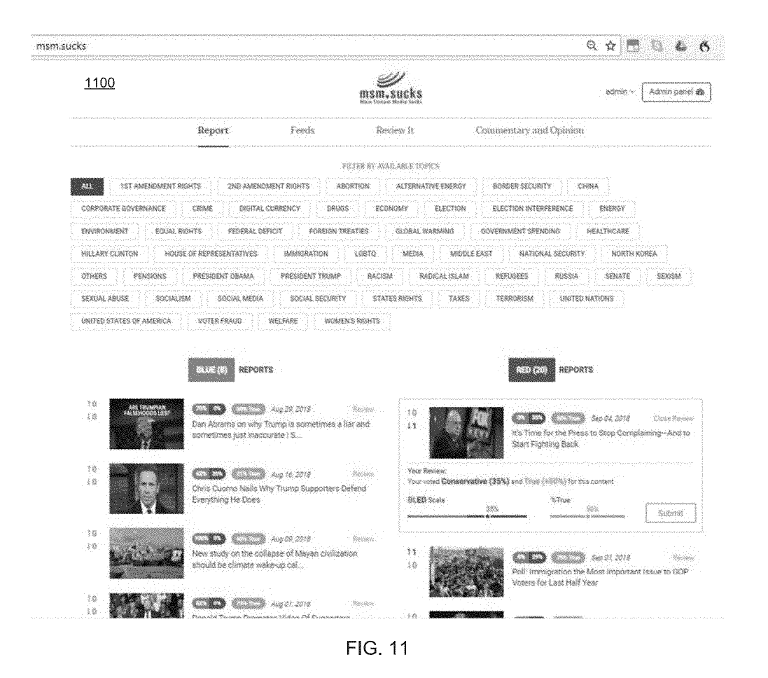

As shown, the indicators 1004 may allow the user to up vote or down vote the content. Any number of ranking schemes may also be utilized. In one embodiment, content that is up voted more frequently may be displayed more prominently in a review page (see for example FIG. 11). Thumbs up or down, numeric rankings, arrows, stars, or other information may be utilized to indicate whether the user likes or dislikes the content or recommends it for others or does not recommend it.

A sliding scale 1006 may be utilized to receive bias information associated with the content. For example, the sliding scale 1006 may allow the user to select between 100% liberal on the far left in blue, zero or completely neutral in the middle, or 100% conservative on the far right in red, or anything in between. Any number of intervals, such as 0.1, 0.5, 1 or 10 may be utilized depending on the desired resolution and granularity. The sliding scale 1006 may also represent opposite sides of an opinion that show bias one way or another, such as pro-life/pro-choice, pro-speech/anti-speech, pro-gun/anti-gun, supporting a video game/opposing a video game, or so forth. The sliding scale 1006 may be customized for particular articles based on relevance. For example, appropriate categories may be automatically or manually assigned to the sliding scale.

A sliding scale 1008 may be utilized to select truthfulness of the content from 0% true (or false) to 100% true (completely true. The sliding scale 1008 as was the other components and elements of the user interface 1000 may represent the perception of the user regardless of whether the user represents himself only, an organization, or so forth.

In one embodiment, a submission button may be utilized to assign the ratings, review, and user selections and information to the content. For example, the information may be associated with a unique identifier for the content. In other embodiments, the user selections may be automatically submitted once the selections are made in case the user forgets to hit the submit button.

Sharing indicators 1010 may be utilized to share the user's personal selections and or the overall selections by numerous users available through the user interface 1000. The sharing indicators 1010 may be utilized to perform social media posts, text messages, email, in application messages, or so forth.

FIG. 11 is a webpage 1100 for displaying content in accordance with an illustrative embodiment. The webpage 1100 may be utilized to display content based on the applicable user selections and reviews. For example, the webpage 1100 may include specific pages for reports, feeds, reviews, and commentary and opinion. The content available through the webpage 1100 may be reviewed or rated (or the review and rating may be changed) at any time by the user. As a result, the webpage 1100 provides a significant level of transparency.

In one embodiment, one or more administrators may select content to display in the “Blue Report” and the “Red Report” representing liberal and conservative content respectively. The administrators may also select content to associate with a red feed or a blue feed. For example, different sources of content may be known for their particular biases and may should be shown accordingly. User reviews may switch the content from one side to another in response to meeting a specified threshold (e.g., 1000 user reviews). The review page (i.e., Review It) may be utilized to compile reviews from tools or platforms, such as the user interface 1000 of FIG. 10. Likewise, the commentary and opinion may show commentary that is associated with a particular bias. The commentary may also be reviewed and an initial categorization of the content (e.g., liberal, conservative, etc.) may change based on the user ratings.

In one embodiment, each piece of content may be associated with one or more topics, metatags, labels, or other information for filtering the available content.

The illustrative embodiments are not to be limited to the particular embodiments and examples described herein. In particular, the illustrative embodiments contemplate numerous variations in the type of ways in which embodiments may be applied to the location devices, methods, systems, software, processes, or so forth described herein. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments disclosed with greater particularity.

What is claimed is:

1. A method for rating content, comprising:
determining content being received by a user;
presenting a user interface for receiving at least a user selection of bias of the content and rating truthfulness of the content to the user;
receiving the user selection of at least the bias of the content and rating the truthfulness of the content from the user through the user interface;
automatically compiling a plurality of user selections of bias and truthfulness for a plurality of users including the user; and
communicating results indicating the plurality of user selections.

2. The method of claim 1, wherein the determining content includes receiving a selection from the user for presenting the user interface.

3. The method of claim 1, wherein receiving the user selection further comprises:
receiving a user selection upvoting or downvoting the content.

4. The method of claim 1, wherein the user interface includes a sliding scale for rating bias of the content as perceived by the user from 0 to 100 percent liberal bias or 0 to 100 percent conservative bias, wherein 0 represents neutral content without bias, and wherein the user interface presents a sliding scale for rating the truthfulness of the content as perceived by the user from 0% or false to 100% or completely true.

5. The method of claim 1, further comprising:
receiving login information from the user prior to receiving the selection of content.

6. The method of claim 1, wherein the user selection is changeable by the user at any time, wherein the

7. The method of claim 1, wherein the user interface is presented through a browser extension or add-in, and wherein the user selection is stored in a database associated with a server as received through the browser extension or add-in.

8. The method of claim 1, further comprising:
sharing the user selection associated with the user through a social media post or one or more messages.

9. The method of claim 1, wherein the user selection further comprises a comment from the user.

10. The method of claim 1, wherein the user interface is configurable to receive different types of bias.

11. The method of claim 1, wherein the user selections are received for web content or mobile application content, and wherein a unique identifier is associated with the content regardless of distribution by multiple sources.

12. A content rating platform, comprising:
a processor for executing a set of instructions; and
a memory for storing the set of instructions, wherein the instructions are executed by the processor to:
determining content being received by a user;
present a user interface for receiving at least a user selection of bias of the content and rating truthfulness of the content to the user;
receive the user selection of at least the bias of the content and rating the truthfulness of the content from the user through the user interface;
automatically compile a plurality of user selections of bias and truthfulness for a plurality of users including the user receiving the content; and
communicate results indicating the plurality of user selections.

13. The content rating platform of claim 12, wherein a unique identifier is associated with the content, wherein the unique identifier is utilized for the content regardless of distribution and sources that provide the content, and wherein the users selections are associated with the unique identifier of the content.

14. The content rating platform of claim 12, wherein the user interface includes a sliding scale for rating bias of the content as perceived by the user from 0 to 100 percent liberal bias or 0 to 100 percent conservative bias, wherein 0 represents neutral content without bias, and wherein the user interface presents a sliding scale for rating the truthfulness of the content as perceived by the user from 0% or false to 100% or completely true.

15. The content rating platform of claim 12, wherein the content rating platform is a server, and wherein the user interface is presented by a browser extension or add-in in response to a user selection of the browser extension or add-in.

16. The content rating platform of claim 12, wherein the results are communicated in response to determining the user is receiving the content.

17. A content management platform, comprising:
one or more web servers connected to one or more networks;
a plurality of content sources communicating with the one or more web servers through the one or more networks, wherein the one or more web servers automatically determine content being received by a user from the plurality of content sources, present a user interface for receiving at least a user selection of bias of the content and rating truthfulness of the content to the user, receive the user selection of at least the bias of the content and rating the truthfulness of the content from the user through the user interface, automatically compile a plurality of user selections of bias and truthfulness for a plurality of users including the user, and communicate results indicating the plurality of user selections.

18. The content management platform of claim 17, wherein a unique identifier is associated with the content, wherein the unique identifier is utilized for the content regardless of distribution and sources that provide the content, and wherein the users selections are associated with she unique identifier of the content.

19. The content management platform of claim 17, wherein the user interface is presented by a browser add-in or extension.

20. The content management platform of claim 17, wherein the one or more web servers share the user selection and user selections through social media or a message in response to a selection by the user.
